(19) United States
(12) Patent Application Publication
(10) Pub. No.: US 2021/0103439 A1
(43) Pub. Date: Apr. 8, 2021

(54) METHODS, WIRELESS MODULES, ELECTRONIC DEVICES AND SERVER DEVICES

(71) Applicant: SONY CORPORATION, Tokyo (JP)

(72) Inventor: Anders MELLQVIST, Malmö (SE)

(21) Appl. No.: 17/054,647

(22) PCT Filed: Jun. 14, 2018
(86) PCT No.: PCT/IB2018/054379

§ 371 Date: Nov. 11, 2020

(51) Int. Cl. G06F 8/65; G06F 11/07; H04W 12/06; H04W 12/108; H04W 12/041

(52) U.S. Cl. CPC G06F 8/65; G06F 11/0721; H04W 12/041; H04W 12/108; H04W 12/06

(57) ABSTRACT

The present disclosure provides a method, performed in a wireless module. The method for securing a software update operation of an electronic device. The wireless module comprises a first interface to a server device and a second interface to the electronic device, a memory module and a processor module. The method comprises receiving a software update request, via the first interface; authenticating the software update request; and in accordance with authentication of the software update request succeeds, providing, via the second interface, software data corresponding to the software update request.

The present disclosure pertains to the field of electronic devices. More specifically, the present disclosure relates to methods for securing a software update operation of an electronic device, wireless modules, electronic devices and server devices thereof.

### BACKGROUND

The number of connected electronic devices is expected to increase rapidly over the coming years. However, security weaknesses in such electronic devices can be exploited to install malicious software that compromise their functionality. An example of such attacks is the Mirai botnet that affected hundreds of thousands of electronic devices.

There is a need for techniques that address the security weaknesses and challenges for such a system.

### SUMMARY

Accordingly, there is a need for methods, wireless modules, electronic devices and server devices that overcome, mitigate or alleviate the security weaknesses while allowing software update operations and management.

The present disclosure provides a method, performed in a wireless module. The method for securing a software update operation of an electronic device. The wireless module comprises a first interface to a server device and a second interface to the electronic device, a memory module and a processor module. The method comprises receiving a software update request, via the first interface; authenticating the software update request; and in accordance with authentication of the software update request succeeds, providing, via the second interface, software data corresponding to the software update request.

The disclosed method provides a robust and secure software management because the disclosed method and related wireless module allow isolating the management of the software update from the system under monitoring (i.e. the electronic device to run the software update), thereby improving the security of the software management, delivery and installation. As the wireless module is an entity independent from the electronic device, the wireless module according to the disclosed method is capable of providing (e.g. forcing) a secure software update to the electronic device even when the electronic device is corrupted, under attack or malfunctioning. This leads to an increased security of the electronic device under monitoring by the wireless module.

The present disclosure relates to a method, performed in an electronic device, for securing a software update operation requested by a wireless module. The electronic device comprises an interface to the wireless module, a memory module and a processor module. The method comprises receiving, via the interface, a mode request for activation of a software update mode, transmitting, via the interface, a mode response, and receiving, via the interface, software data.

The method performed in the electronic device advantageously provide a robust, scalable and secure software deployment to the electronic devices. Further, the related methods are advantageously easily deployable without human intervention.

The present disclosure provides a method, performed in a server device, for supporting a software update operation, wherein the server device comprises an interface to the wireless module, a memory module and a processor module. The method comprises: generating a software update request, the software update request comprising a device identifier and a software identifier; and transmitting the software update request, via the interface to the wireless module.

The method performed in the server device provides a server device which supports in achieving a robust, deployable and secure software management architecture for electronic devices (e.g. IoT devices).

The present disclosure relates to a wireless module comprising a first interface to a server device and a second interface to an electronic device, a memory module and a processor module, wherein the wireless module is configured to perform any of the methods disclosed herein.

The present disclosure relates to an electronic, device, comprising an interface, a memory module and a processor module, wherein the electronic device is configured to perform any of the methods disclosed herein.

The present disclosure relates to a server device, comprising an interface, a memory module and a processor module, wherein the server device is configured to perform any of the methods disclosed herein

The wireless modules, the electronic devices, the server devices provide advantages corresponding to the advantages already described in relation to the methods performed by the wireless module, the electronic device, and the server device respectively.

### BRIEF DESCRIPTION OF THE DRAWINGS

The above and other features and advantages of the present disclosure will become readily apparent to those skilled in the art by the following detailed description of exemplary embodiments thereof with reference to the attached drawings, in which:

FIG. 1 is a flow diagram of an exemplary method, performed in a wireless module, for securing a software update operation of an electronic device according to the disclosure,

FIG. 2 is a flow diagram of an exemplary method, performed in an electronic device, for securing a software update operation requested by a wireless module according to the disclosure,

FIG. 3 schematically illustrates an exemplary wireless module according to the disclosure,

FIG. 4 is a flow diagram of an exemplary method, performed in a server device, for supporting a software update operation according to the disclosure,

FIG. 5 schematically illustrates an exemplary electronic device according to the disclosure,

FIG. 6 schematically illustrates an exemplary server device according to the disclosure,

FIG. 7 schematically illustrate an exemplary system according to the disclosure, and

FIG. 8 is a signaling diagram illustrating exemplary communications between an exemplary server device, an exemplary wireless module, an exemplary electronic device, and an exemplary external electronic device.

### DETAILED DESCRIPTION

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

The present disclosure is seen as related to electronic devices where a software update is to be performed. The present disclosure is seen as also related to Internet-of-Things (IoT) communications.

Security of IoT electronic devices is a challenge. Once an IoT device is compromised, it is difficult, if not impossible, to patch or restore the software to run on the IoT device because the malicious software may prevent it.

The present disclosure aims at securing software update operations of electronic devices such as IoT devices. An IoT communication system can be seen as a communication system comprising one or more electronic devices (e.g. low throughput devices, low delay sensitivity devices, ultra-low cost devices, low-power devices). Examples of IoT devices include a smart meter, an electronic device adapted to control or monitor an object in e.g. a manufacturing process, an agricultural process, a home environment, a sale process, and/or a warehouse environment). The IoT communication system can be for example a home system. The IoT communication system may comprise a massive number of electronic devices.

The deployment of IoT devices is usually massive and therefore the software update operations on such devices requires time and man resources to perform. Thus, it is envisaged in the present disclosure to provide solutions that enable software update operations to be performed via wireless communication. However, to do so, it is necessary to ensure that the software update operations are performed securely including when the electronic IoT device has been corrupted.

The figures are schematic and simplified for clarity, and they merely show details which are essential to the understanding of the invention, while other details have been left out. Throughout, the same reference numerals are used for identical or corresponding parts.

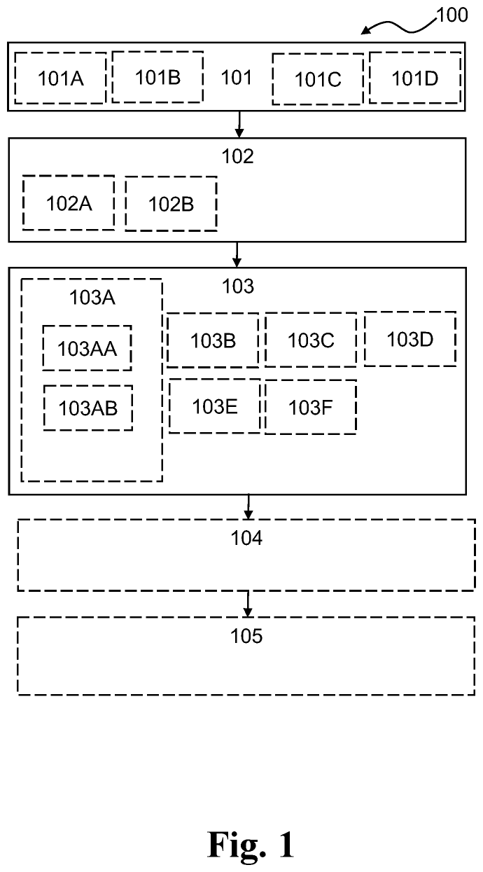

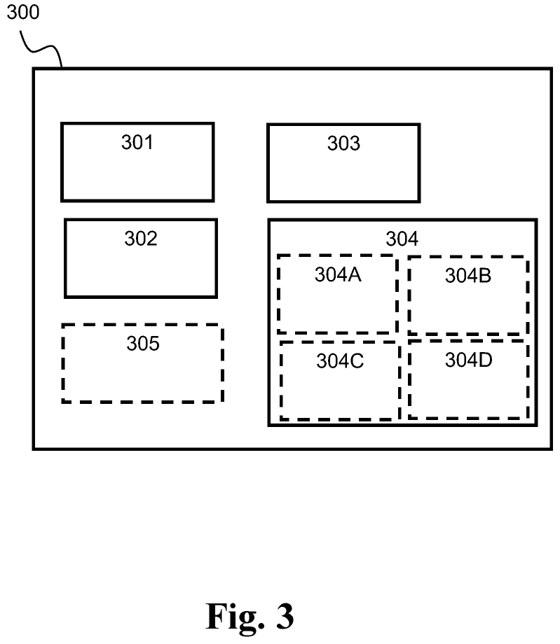

FIG. 1 shows a flow diagram of an exemplary method 100, performed in a wireless module (e.g. a wireless module disclosed herein, e.g. in FIG. 3). The method 100 for securing a software update operation of an electronic device (e.g. an electronic device configured to act as an IoT device). A software update operation refers to an operation involving an update of one or more parts of a software installed on the electronic device. Examples of software update operations include firmware update operations, and operating system update operations. The term “firmware” refers to a software piece that is generated for an electronic device taking into account one or more of: the electronic device resources, the electronic device hardware and a use case of consideration for the electronic device. The term “operating system” refers to a general purpose software configured to execute general purpose functionalities of the electronic device. The term software may refer to instructions running in an electronic device where the instructions are modifiable and/or where instructions are stored in a read-only memory. Software in read-only memory may be patched by storing the software update in a writeable memory and redirecting the processor of the electronic device to the writeable memory.

The wireless module comprises a first interface to a server device and a second interface to the electronic device, a memory module and a processor module.

The method 100 comprises receiving 101 a software update request, via the first interface, from the server device. Optionally, receiving 101 the software update request comprises receiving the software update request periodically from the server device via the first interface. Optionally, receiving 101 the software update request comprises polling the server device periodically for software update requests via the first interface, and receiving the software update request periodically from the server device via the first interface in response to the polling. Polling the server device may be performed by sending a polling request to the server device.

The method 100 comprises authenticating 102 the software update request. The method 100 comprises in accordance with authentication of the software update request succeeds, providing 103, via the second interface, software data corresponding to the software update request. Optionally, providing 103, in accordance with authentication of the software update request succeeds, software data comprises transmitting 103E, via the second interface to the electronic device, a mode request for activation of a software update mode of the electronic device, e.g. prior to providing the software data and/or the electronic-device software data. For example, transmitting 103E, via the second interface to the electronic device, a mode request for activation of a software update mode of the electronic device comprises setting a reset pin of the electronic device to enable the transferring of the electronic-device software data from the wireless module to the electronic device.

The wireless module for example provides the software data to the electronic device via the second interface (e.g. a universal asynchronous receiver/transmitter (UART), serial peripheral interface (SPI), Universal Serial Bus (USB) interface).

The disclosed method provides a robust and secure software management and delivery, because the disclosed method and wireless module permits to isolate the management of the software update from the system under monitoring (i.e. the electronic device to receive the software update), thereby improving the security of the software management. The wireless module is an entity independent from the electronic device in that a corruption or malfunctioning of the electronic device does not result in a corruption or malfunctioning of the wireless module. As the wireless module is independent from the electronic device, the wireless module according to the disclosed method is capable of providing (e.g. forcing) a secure software update to the electronic device even when the electronic device is corrupted, under attack or malfunctioning. This leads to an increased security of the electronic device under monitoring by the wireless module. In other words, the present disclosure permits a secure recovery of the electronic device. When the wireless module 300 is instructed by the backend to perform a firmware update it downloads a data package from the server and loads into the memory of the main system according to the functioning of this particular device type.

Optionally, receiving 101 the software update request from the server device via the first interface comprises receiving a notification (e.g. text message, a short message service (SMS), an application-generated notification) from the server device

Optionally, when the software update request comprises a message authentication code generated by the server device or a digital signature generated by the server device, authenticating 102 the software update request comprises authenticating 102A the sender of the software update request, by e.g. verifying the message authentication code or the digital signature using cryptographic material shared with the server device. This results in providing robustness against impersonation attacks. Optionally, authenticating 102 the software update request comprises verifying (102B) integrity of the software update request by e.g. verifying the message authentication code (MAC). This results in providing robustness against man-in-the-middle attacks, and modification attacks.

In one or more exemplary methods and wireless modules, the method 100 comprises detecting 101A a failure of the electronic device (via the second interface), and in response to detecting the failure, transmitting 101B a polling request via the first interface, to the server device. This results in providing robustness of the electronic device when malfunctioning, due to an attack or an operational error.

In one or more exemplary methods and wireless modules, receiving 101 the software update request via the first interface comprises transmitting 101C a polling request to the server device via the first interface periodically according to a period parameter configured in the wireless module, and in response to the polling request, receiving 101D the software update request via the first interface from the server device.

In one or more exemplary methods and wireless modules, the method 100 comprises rejecting 104 the software update request in accordance with authentication of the software update request fails. It may be appreciated that rejecting the software update request according to the failure of the authentication of the software update request leads to an increased security against attacker attempting to compromise the electronic device or the wireless module by impersonating a legitimate server device.

In one or more exemplary methods and wireless modules, the software update request comprises software data corresponding to the software update request. This may provide power efficiency to the wireless module (because the deployment of the software update may be performed based on a software update request.)

In one or more exemplary methods and wireless modules, the software update request is encrypted using a symmetric key. For example, the method 100 comprises: decrypting 105 the software update request using the symmetric key. The symmetric key may be derivable from a symmetric keying material provided at manufacturing of the wireless module or of the electronic device. The method 100 optionally comprises generating a symmetric key based on the symmetric keying material and a counter (using e.g. a hash function) wherein the counter is provided in the software update request. In exemplary methods and wireless modules, the symmetric key comprises a session key generated by performing an authenticated key exchange protocol with the server device. The authenticated key exchange protocol may be based on common secret or a public key infrastructure. In one or more exemplary methods and wireless modules, the symmetric key or the common secret are stored in the memory module of the wireless module at manufacturing. It can be appreciated that encryption of the software update request provides robustness against eavesdropping, and increases confidentiality of the content of the software update request.

In one or more exemplary methods and wireless modules, in accordance with authentication of the software update request succeeds, providing 103, to the electronic device, software update data corresponding to the software update request comprises: receiving 103A software data via the first interface, authenticating 103B the received software data (e.g. by verifying integrity, e.g. by authenticating sender, e.g. using MAC or a digital signature); and in accordance with authentication of the software data succeeds: storing 103C electronic-device software data in a part of the memory module based on the received software data; and providing 103D the electronic device software data via the second interface (e.g. transmitting via the second interface, e.g. by setting a reset pin of the electronic device to enable the transferring of the electronic-device software data from the wireless module). This may lead to increasing the robustness against impersonation and modification attacks when the electronic-device software data is delivered separately from the software update request. It may be envisaged that the electronic-device software data is the same or not as the received software data. Optionally, the received software data may be received by the wireless module in encrypted form and may be provided as electronic-device software data to the electronic device wherein the electronic-device software data may be seen as the received software data in decrypted form. Optionally, the received software data may be received by the wireless module in encrypted form and provided in encrypted form, whereby the electronic-device software data is the same as the received software data.

In one or more exemplary methods and wireless modules, the method 100 comprises receiving 103A the software data via the first interface comprises transmitting 103AA, via the first interface to the server device, a software data request based on the software update request, and receiving 103AB, via the first interface from the server device, a software data response comprising the software data corresponding to the software update request. This increases the security of the management of the software update.

In one or more exemplary methods and wireless modules, in accordance with authentication of the software update request succeeds, providing 103, via the second interface, software data corresponding to the software update request comprises in accordance with authentication of the software update request succeeds: transmitting 103E, via the second interface to the electronic device, a mode request for activation of a software update mode of the electronic device, e.g. prior to providing the software data and/or the electronic-device software data. Optionally, the mode request is a software command from the wireless module to the electronic device. Optionally, transmitting 103E, via the second interface to the electronic device, a mode request for activation of a software update mode of the electronic device comprises setting a reset pin of the electronic device to enable the transferring of the electronic-device software data from the wireless module to the electronic device. This leads to an additional security level for wireless module because it requires a mode request accept by the electronic device.

In one or more exemplary methods and wireless modules, the method 100 comprises receiving 103F, via the second interface from the electronic device, a mode response.

The mode response optionally comprises a mode accept indicator, or a mode reject indicator.

In one or more exemplary methods and wireless modules, the mode request comprises a reset request to the electronic device for resetting the electronic device (e.g. for setting a reset pin of the electronic device to enable the transferring of the electronic-device software data from the wireless module to the electronic device). In one or more exemplary methods and wireless modules, the mode response comprises a reset response. This leads to an additional security level for wireless module because it requires a reset accept by the electronic device. The reset response optionally comprises a reset accept indicator, or a reset reject indicator.

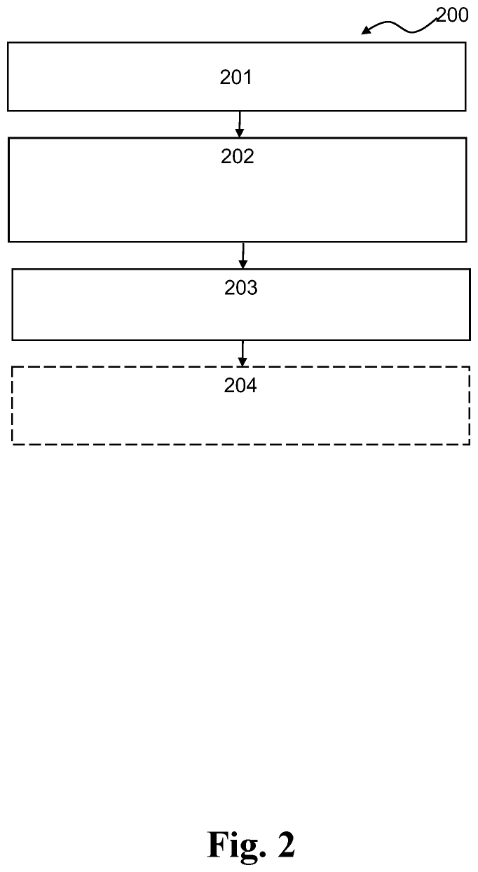

FIG. 2 is a flow diagram of an exemplary method 200, performed in an electronic device, for securing a software update operation requested by a wireless module according to the disclosure. The electronic device comprises an interface to the wireless module, a memory module and a processor module. The method 200 comprises receiving 201, via the interface, a mode request for activation of a software update mode, transmitting 202, via the interface, a mode response, and receiving 203, via the interface, software data.

The electronic devices disclosed herein, and the related methods advantageously provide a robust, scalable and secure software management of the electronic devices. Further, the electronic devices disclosed herein, and the related methods are advantageously easily deployable without human intervention.

In one more exemplary methods and electronic devices, the method 200 comprises storing 204 the software data in a part of the memory module of the electronic device. Additionally, or alternatively, the method 200 comprises storing electronic-device software data based on the received software data.

FIG. 3 shows a block diagram illustrating an exemplary wireless module 300 according to the disclosure. The wireless module 300 comprises a first interface 301 to a server device and a second interface 302 to the electronic device, a memory module 303 and a processor module 304. The wireless module 300 comprises optionally a secure hardware module 305 configured to store cryptographic material and to perform cryptographic functions according to this disclosure. The secure hardware module 305 comprises for example a tamper-resistant module optionally acting as a trust anchor.

The first interface 301 is configured to receive a software update request from the server device (optionally, to receive the software update request periodically from the server device). When the wireless module 300 is instructed by a server device (e.g. a backend server device) to perform a software update, the wireless module 300 for example downloads a software data from the server device and loads into the memory of the electronic device according to the functioning of this particular electronic device type.

The processor module 304 is configured to authenticate the software update request (e.g. via an authenticator module 304A). The processor module 304 is configured to, in accordance with authentication of the software update request succeeds, provide, via the second interface 302, software data corresponding to the software update request. The second interface 302 comprises for example a universal asynchronous receiver/transmitter (UART), serial peripheral interface (SPI), USB interface.

The disclosed wireless module 300 provides a robust and secure software management and delivery to an electronic device connected to the wireless module 300, because the disclosed wireless module 300 allows to isolate the management of the software update from the system under monitoring (i.e. the electronic device to run the software update), thereby improving the security of the software management. The disclosed wireless module 300 provides a dedicated component which improves the security of the electronic device under monitoring. The connection to the electronic device can be seen as a managed and possibly always-on connectivity.

Optionally, the processor module 304 is configured to detect a failure of the electronic device (via the second interface 302 or via a detector module 304B), and in response to detecting the failure, to transmit a polling request via the first interface 301, to the server device.

Optionally, the processor module 304 is configured to reject (e.g. via a rejector module 304C) the software update request in accordance with authentication of the software update request fails.

Optionally, the processor module 304 is configured to decrypt (e.g. via a decryptor module 304D or via the hardware secure module 305) the software update request using the symmetric key or using a public key using public key infrastructure.

The wireless module 300 is configured to communicate with the server device using wireless communications systems such as cellular systems (e.g. Narrowband IoT, e.g. low cost Narrowband IoT or category M).

The processor module 304 is optionally configured to perform any of the operations disclosed in FIG. 1. The operations of the wireless module 300 may be embodied in the form of executable logic routines (e.g., lines of code, software programs, etc.) that are stored on a non-transitory computer readable medium (e.g., the memory module 303) and are executed by the processor module 304).

Furthermore, the operations of the wireless module 300 may be considered a method that the wireless module is configured to carry out. Also, while the described functions and operations may be implemented in software, such functionality may as well be carried out via dedicated hardware or firmware, or some combination of hardware, firmware and/or software.

The memory module 303 may be one or more of a buffer, a flash memory, a hard drive, a removable media, a volatile memory, a non-volatile memory, a random access memory (RAM), or other suitable device. In a typical arrangement, the memory module 303 may include a non-volatile memory for long term data storage and a volatile memory that functions as system memory for the processor module 304. The memory module 303 may exchange data with the processor module 304 over a data bus. Control lines and an address bus between the memory module 303 and the processor module 304 also may be present (not shown in FIG. 3). The memory module 303 is considered a non-transitory computer readable medium.

The memory module 303 may be configured to store electronic-device software data in a part of the memory based on the received software data.

It may be appreciated that the wireless module 300 is configured to be integrated (e.g. via a hardware integration) with an electronic device (e.g. with the main system of the electronic device) that permits the wireless module 300 to access various functionalities of the electronic device, e.g. restarting the electronic device, and/or putting the electronic device in software update mode. The wireless module 300 is configured to communicate exclusively with an associated server device and the electronic device.

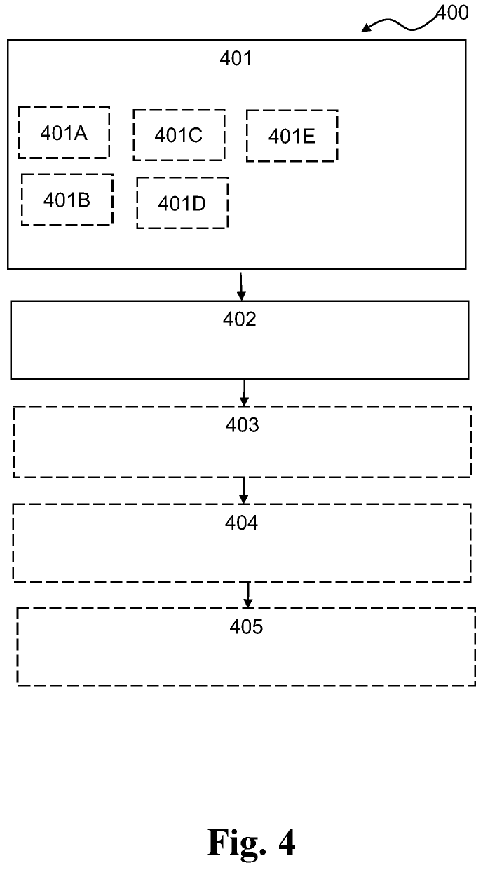

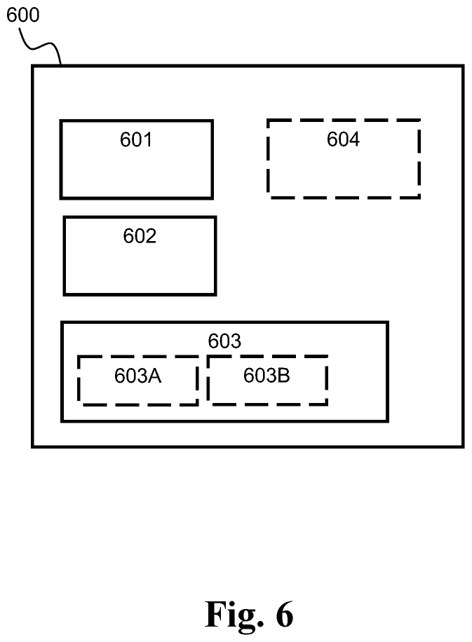

FIG. 4 is a flow diagram of an exemplary method 400, performed in a server device (e.g. a server device disclosed herein, e.g. server device 600 of FIG. 6), for supporting a software update operation according to the disclosure.

The method 400 is performed for supporting a software update operation at an electronic device. The server device comprises an interface to the wireless module, a memory module and a processor module.

The method 400 comprises generating 401 a software update request, the software update request comprising a device identifier and a software identifier; and transmitting 402 the software update request, via the interface to the wireless module. A device identifier may comprise a batch identifier, and/or a model type identifier, and/or a hardware device identifier, and/or a serial number. Optionally, the step of transmitting 402 is performed periodically.

The server device disclosed herein, and the related method provide a robust, deployable and secure software management architecture for the electronic devices (e.g. IoT devices).

In one or more exemplary methods and server devices, generating 401 the software update request comprises generating 401A an authentication and integrity indicator based on a payload of the software update request (e.g. by performing a digital signature or a MAC over the payload of the software update request). Generating 401 may comprise including 401B the authentication and integrity indicator in the software update request. The authentication and integrity indicator comprises one or more of: a message authentication code, and a digital signature. This advantageously provides increased security against impersonation attacks, and modification attacks.

Optionally, generating 401 the software update request comprises generating 401C software data and including the software data in the software update request. By generating the software update request according to operation 401C, the server device enables power savings at the wireless module that has power constraints. Because the wireless module is not required in this example to request the software data separately.

In one or more exemplary methods and server devices, the method 400 comprises receiving 403, via the interface from the wireless module, a software data request based on the software update request, authenticating 404 the software data request; and transmitting 405, via the interface to the wireless module. The software data response comprises software data corresponding to the software data request. For example, the software update request comprises a software identifier to be used in the software data request to the server device for retrieving the software data. For example, the software update request comprised an electronic device identifier that enables the server device to determine the software data to be sent in response to the software data request.

In one or more exemplary methods and server devices, generating 401 the software update request comprises receiving 401D an action request via an additional interface, from an external electronic device (e.g. a manufacturer electronic device, a servicing electronic device, an electronic device of a maintenance service provider). The external electronic device is controlled by a service provider, and/or a manufacturer (e.g. an original equipment manufacturer) of an electronic device configured to communicate with the wireless module. The external electronic device may be seen as an electronic device external to the software update management architecture comprising the wireless module and the server device. The action request is for example a publication of software for updating a set of electronic devices. Generating 401 the software update request optionally comprises authenticating the action request from the external electronic device. Generating 401 the software update request optionally comprises in response to the action request, generating 401E a software update request based on the action request.

In other words, the server device controls the authentication of the action request and related software data provided by the external electronic device. The server device sends the software update request to the wireless module upon the action request from an external electronic device, which has an over-the-air programming interface, or an application programming interface to the server device. The external electronic device indicates to the server device the availability of new software data for software update of the electronic device manufactured. It is an advantage of the present disclosure that the computational and power resources of the server device are exploited permitting the electronic device to be managed even when the electronic device has limited computational capabilities and technical configurations.

It is envisaged that the external electronic device publishes a new software version on the server device, by using e.g. an over-the-air programming interface, e.g. using application programming interface and/or web interface, and indicates a set of electronic devices to target for software update. The electronic device to be updated needs no adaptation for the present disclosure to carried out. The wireless module together with the server device ensure that the correct software data is received and provided to the electronic device in the targeted set of devices. The electronic device itself is activated by the wireless module to go into software update mode.

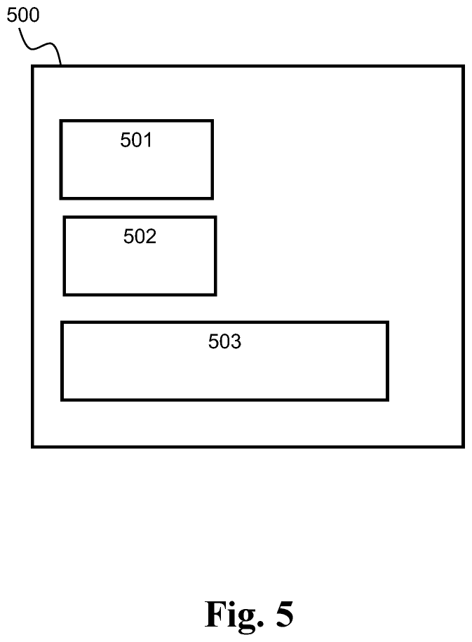

FIG. 5 schematically illustrates an exemplary electronic device 500 according to the disclosure. The electronic device 500 is for example an IoT device.

The electronic device 500 comprises an interface 501 to the wireless module disclosed herein, a memory module 502 and a processor module 503. The electronic device is configured to receive, via the interface 501, a mode request for activation of a software update mode, to transmit, via the interface 501, a mode response, and to receive, via the interface 501, software data.

The electronic devices disclosed herein advantageously provides a robust, scalable and secure software management of the electronic devices. Further, the electronic devices disclosed herein is advantageously easily deployable without human intervention.

The memory module 502 is configured to store the software data in a part of the memory module 502 of the electronic device. Additionally, or alternatively, the memory module 502 is configured to store electronic-device software data based on the received software data.

The processor module 503 is optionally configured to perform any of the operations disclosed in FIG. 2. The operations of the electronic device 500 may be embodied in the form of executable logic routines (e.g., lines of code, software programs, etc.) that are stored on a non-transitory computer readable medium (e.g., the memory module 502) and are executed by the processor module 503).

Furthermore, the operations of the electronic device 500 may be considered a method that the corresponding device is configured to carry out. Also, while the described functions and operations may be implemented in software, such functionality may as well be carried out via dedicated hardware or firmware, or some combination of hardware, firmware and/or software.

FIG. 6 schematically illustrates an exemplary server device 600 according to the disclosure. The server device 600 is configured to support a software update operation at an electronic device according to the disclosure.

The server device 600 comprises an interface 601 to the wireless module (e.g. the wireless module disclosed herein, e.g. wireless module 300), a memory module 602 and a processor module 603. Optionally, the server device 600 comprises an additional interface 604 to an external electronic device.

The processor module 603 is configured to generate a software update request (e.g. via a generator module 603A). The software update request comprises a device identifier and a software identifier.

The interface 601 is configured to transmit the software update request to the wireless module. A device identifier may comprise a batch identifier, and/or a model type identifier, and/or a hardware device identifier, and/or a serial number. Optionally, the interface 601 is configured to transmit the software update request periodically.

The server device 600 supports a robust, deployable and secure software management architecture for the electronic devices (e.g. IoT devices).

In one or more exemplary server devices, the processor module 603 is configured to generate the software update request by generating (via e.g. the generator module 603A) an authentication and integrity indicator based on a payload of the software update request (e.g. by performing a digital signature or a MAC over the payload of the software update request). The processor module 603 may be configured to generate (via e.g. the generator module 603A) the software update request by including 401B the authentication and integrity indicator in the software update request. The authentication and integrity indicator comprises one or more of: a message authentication code, and a digital signature. This advantageously provides increased security against impersonation attacks, and modification attacks.

The interface 601 may be configured to receive from the wireless module, a software data request based on the software update request.

The processor module 603 is optionally configured to authenticate (e.g. using an authenticator module 603B) the software data request, and to transmit, via the interface 601, to the wireless module. The software data response comprises software data corresponding to the software data request. For example, the software update request comprises a software identifier to be used in the software data request to the server device for retrieving the software data. For example, the software update request comprised an electronic device identifier that enables the server device to determine the software data to be sent in response to the software data request.

In one or more exemplary server devices, the processor module 603 is configured to generate the software update request by receiving an action request via an additional interface 604, from an external electronic device, by authenticating the action request from the external electronic device and by generating a software update request based on the action request in response to the action request.

The processor module 603 is optionally configured to perform any of the operations disclosed in FIG. 4. The operations of the server device 600 may be embodied in the form of executable logic routines (e.g., lines of code, software programs, etc.) that are stored on a non-transitory computer readable medium (e.g., the memory module 602) and are executed by the processor module 603).

Furthermore, the operations of the server device 600 may be considered a method that the corresponding device is configured to carry out. Also, while the described functions and operations may be implemented in software, such functionality may as well be carried out via dedicated hardware or firmware, or some combination of hardware, firmware and/or software.

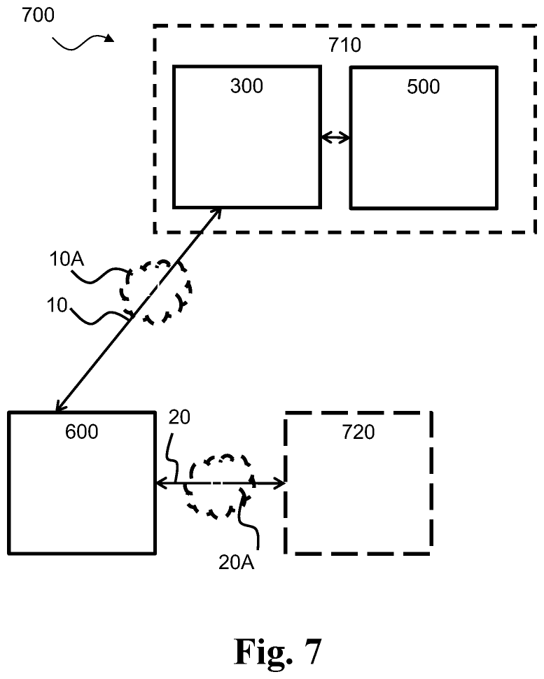

FIG. 7 schematically illustrate an exemplary system 700 according to the disclosure. The system 700 comprises a wireless module 300, a server device 600, and an electronic device 500. The wireless module 300 is configured to communicate with the server device 600 via communication link 10, e.g. via a wireless communication network 10A.

In one or more exemplary systems, the electronic device 500 is external to the wireless module 300.

In one or more exemplary systems, the wireless module 300 and the electronic device 500 form part of a secure electronic device 710.

The system 700 may comprise an external electronic device 720 capable of connecting via a link 20 to the server device 600 via a communication system 20A (e.g. a network communication system).

The server device 600 controls authentication of action requests and related software data provided by the external electronic device 720. The server device 600 sends the software update request to the wireless module 300 upon the action request from an external electronic device 720, which has an application programming interface to the server device. The external electronic device 720 indicates to the server device 600 the availability of new software data for software update of the electronic device 500 manufactured. It is an advantage of the present disclosure that the computational and power resources of the server device 600 are exploited permitting the electronic device 500 to be managed even when the electronic device 500 has limited computational capabilities and technical configurations.

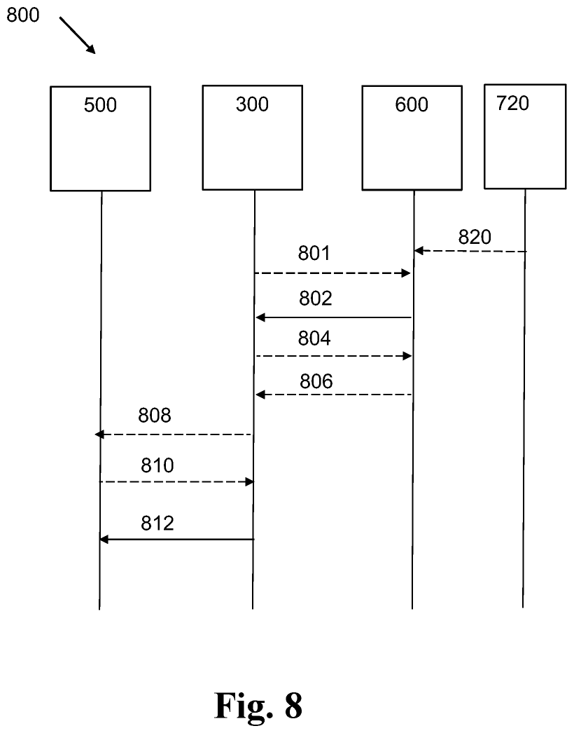

FIG. 8 is a signaling diagram 800 illustrating exemplary communications between an exemplary server device 600, an exemplary wireless module 300 an exemplary electronic device 500, and an exemplary external electronic device 720.

For example, an external electronic device 720 provides or transmits an action request 820 to the server device 600. The action request 820 may comprise software data for update, and one or more device identifiers corresponding to the one or more electronic devices to be updated.

The server device 600 transmits a software update request 802 to the wireless module 300, which optionally include the software data. Optionally, the wireless module 300 transmits a polling request 801 to the server device 600, which requests a software update from the server device 600 because the wireless module 300 has detected a failure of the electronic device 500.

Optionally, the wireless module 300 requests software data (when not included in the software update request) by transmitting a software data request 804 to the server device 600 and receiving a software data response 806 comprising the software data to be installed on the electronic device 500 in accordance with authentication of the software update request succeeds (e.g. by verifying integrity, e.g. by authenticating sender, e.g. using MAC or a digital signature).

Optionally, the wireless module 300 transmits to the electronic device 500 a mode request 808 for activation of a software update mode of the electronic device 500.

Optionally, the wireless module 300 receives from the electronic device 500 a mode response 810.

The wireless module 300 provides the software data 812 to the electronic device 500.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1-8 comprises some modules or operations which are illustrated with a solid line and some modules or operations which are illustrated with a dashed line. The modules or operations which are comprised in a solid line are modules or operations which are comprised in the broadest example embodiment. The modules or operations which are comprised in a dashed line are example embodiments which may be comprised in, or a part of, or are further modules or operations which may be taken in addition to the modules or operations of the solid line example embodiments. It should be appreciated that these operations need not be performed in order presented. Furthermore, it should be appreciated that not all of the operations need to be performed. The exemplary operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the exemplary embodiments may be implemented at least in part by means of both hardware and software, and that several “means”, “units” or “devices” may be represented by the same item of hardware.

The various exemplary methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform specified tasks or implement specific abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed invention, and it will be made obvious to those skilled in the art that various changes and modifications may be made without departing from the spirit and scope of the claimed invention. The specification and drawings are, accordingly to be regarded in an illustrative rather than restrictive sense. The claimed invention is intended to cover all alternatives, modifications, and equivalents.

1. A method, performed in a wireless module, for securing a software update operation of an electronic device, wherein the wireless module comprises a first interface to a server device and a second interface to the electronic device, a memory module and a processor module, the method comprising:
receiving a software update request, via the first interface;
authenticating the software update request; and
in accordance with authentication of the software update request succeeds, providing, via the second interface, software data corresponding to the software update request.

2. The method according to claim 1, the method comprising:
detecting a failure of the electronic device; and
in response to detecting the failure, transmitting a polling request via the first interface.

3. The method according to claim 1, the method further comprising:
rejecting the software update request in accordance with a failure of authentication of the software update request.

4. The method according to claim 1, wherein the software update request comprises software data corresponding to the software update request.

5. The method according to claim 1, wherein authenticating the software update request comprises authenticating a sender of the software update request.

6. The method according to 1, wherein authenticating the software update request comprises verifying integrity of the software update request.

7. The method according to claim 1, wherein the software update request is encrypted using a symmetric key, the method further comprising:
decrypting the software update request using the symmetric key.

8. The method according to claim 1, wherein in accordance with success of authentication of the software update request, providing, to the electronic device, software update data corresponding to the software update request by performing operations comprising:
receiving software data via the first interface;
authenticating the software data that was received; and
in accordance with the success of the authentication of the software data performing operations comprising:
storing electronic device software data in a part of the memory module based on the received software data; and
providing the electronic device software data via the second interface.

9. The method according to claim 8, wherein receiving the software data via the first interface comprises:
transmitting, to the server device, a software data request based on the software update request; and
receiving, from the server device, a software data response comprising the software data corresponding to the software update request.

10. The method according to claim 8, wherein in accordance with the success of the authentication of the software update request performing operations comprising:
providing, via the second interface, software data corresponding to the software update request; and
transmitting, via the second interface to the electronic device, a mode request for activation of a software update mode of the electronic device.

11. The method according to claim 10, wherein the mode request comprises a reset request to the electronic device for resetting the electronic device.

12. A method, performed in a server device, for supporting a software update operation, wherein the server device comprises an interface to a wireless module, a memory module, and a processor module, the method comprising:
generating a software update request, the software update request comprising a device identifier and a software identifier; and
transmitting the software update request, via the interface to the wireless module.

13. The method according to claim 12, wherein generating the software update request comprises:
generating an authentication and integrity indicator based on a payload of the software update request and
including the authentication and integrity indicator in the software update request,
wherein the authentication and integrity indicator comprises one or more of a message authentication code or a digital signature.

14. The method according to claim 12, the method further comprising:
receiving, via the interface from the wireless module, a software data request based on the software update request;
authenticating the software data request; and
transmitting, via the interface to the wireless module, a software data response comprising software data corresponding to the software data request.

15. The method according to claim 12, wherein generating the software update request comprises:
receiving an action request via an additional interface, from an external electronic device; and
in response to the action request, generating a software update request based on the action request.

16. A wireless module comprising a first interface to a server device and a second interface to an electronic device, a memory module and a processor module, wherein the wireless module is configured to perform the method according to claim 1.

17. The method according to claim 1, wherein the wireless module is configured to communicate with the server device using a cellular system.

18. The method according to claim 1, wherein the software data comprises an operating system update.

19. The method according to claim 2, wherein the failure of the electronic device comprises corruption of the electronic device, attack of the electronic device, or malfunctioning of the electronic device.

20. The method according to claim 12, wherein the device identifier is selected from one or more of a batch identifier, a model type identifier, a hardware device identifier, and a serial number.
